(19) United States
(12) Patent Application Publication
(10) Pub. No.: US 2026/0044883 A1
(43) Pub. Date: Feb. 12, 2026

(54) INVOICE PROCESSING SYSTEM AND METHOD

(71) Applicant: Kavin Khadgi, Jackson Heights, NY (US)

(72) Inventor: Kavin Khadgi, Jackson Heights, NY (US)

(21) Appl. No.: 19/364,354

(22) Filed: Oct. 21, 2025

Related U.S. Application Data
(63) Continuation-in-part of application No. 18/053,065, filed on Nov. 7, 2022, now abandoned.
(60) Provisional application No. 63/280,277, filed on Nov. 17, 2021.

(51) Int. Cl. G06Q 30/04; G06Q 30/0601; G06V 30/413

(52) U.S. Cl. CPC G06Q 30/04; G06Q 30/06313; G06V 30/413

(57) ABSTRACT

An invoice processing system configured to match a customer to a vendor based on independently received customer information. The system receives a first set of customer data from a customer, a second set of customer data and invoice data from a vendor, and matches the customer with the vendor using a matching algorithm. Optical character recognition and machine learning may be used to extract and classify customer data. The system may also standardize vendor data, facilitate vendor discovery based on keywords and search queries, and match customers to other vendors offering similar products or services.

### CROSS-REFERENCE TO RELATED APPLICATIONS

This application is a continuation-in-part of U.S. non-provisional patent application Ser. No. 18/053,065, filed on Nov. 7, 2022, which claims the benefit of U.S. provisional patent application No. 63/280,277, filed on Nov. 17, 2021, the contents of which are incorporated by reference in their entirety.

### BACKGROUND

### Field of the Invention

The present invention relates generally to business data processing, and, in particular, to an invoice processing system and method.

### Scope of the Prior Art

For business customers, handling vendor invoices is often a complex task. A lot of the work is performed manually as most vendors still use post mail services to send invoices in the form of a printed copy. In return, customers fulfil the invoices by mailing checks back to the vendor.

Some vendors do have their own web service in which customers can log in to view invoices and statements. However, for customers who have accounts with many vendors, it quickly becomes impossible to keep track of invoices and payments. Often customers end up incurring additional late payment fees. As evidenced, the entire process of handling invoices is rather tedious. Therefore, there is a need for improved methods and systems for facilitating the transfer of vendor invoices and customer payments, all through a centralized application.

### SUMMARY

Embodiments described herein relate to systems, methods, and non-transitory computer-readable media for processing invoice data by matching a customer to a vendor based on independently received customer information. The invoice processing system can be configured to receive a first set of customer data from a customer, a second set of customer data from a vendor, and invoice data associated with the customer from the vendor. The invoice processing system can be further configured to match the customer with the vendor based on the first and second sets of customer data using a matching algorithm. Upon successful matching, the customer is permitted to access the vendor-provided invoice data.

In some embodiments, the second set of customer data may be extracted from one or more digital invoices provided by the vendor, using optical character recognition (OCR) techniques and raw text classification modules. A machine learning module may be employed to classify extracted raw text and identify relevant customer data fields.

In some embodiments, the invoice processing system may be further configured to receive mapping information from the vendor and to standardize the second set of customer data based on the received mapping information.

The invoice processing system may receive vendor-provided keywords, receive a customer-provided search query, and identify one or more vendors whose keywords correspond to the search query. Vendor information, including promotional materials, may then be transmitted to the customer to facilitate vendor discovery and customer engagement.

In another embodiment, the invoice processing system can be configured to identify products and/or services received by the customer based on the invoice data and matching the customer to other vendors offering similar products and/or services. For example, after receiving invoice data from another vendor, the invoice processing system may identify overlap in products or services and match the customer to the other vendor accordingly.

### BRIEF DESCRIPTION OF THE DRAWINGS

The foregoing summary, as well as the following detailed description of preferred variations of the invention, will be better understood when read in conjunction with the appended drawings. For the purpose of illustrating the invention, there is shown in the drawings variations that are presently preferred. It should be understood, however, that the invention is not limited to the precise arrangements shown. In the drawings, where:

FIG. 1 is a block diagram illustrating example physical components (e.g. hardware) of an invoice processing system, according to an embodiment.

FIG. 2 is a flowchart showing steps of an invoice processing method, according to an embodiment.

FIG. 3 is a flowchart showing steps of an invoice processing method, according to another embodiment.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations. Wherever convenient, the same reference numbers will be used throughout the drawings to refer to same or like parts.

Moreover, while variations described herein are primarily discussed in the context of an invoice processing system, it will be recognized by those of ordinary skill that the present disclosure is not so limited. In fact, the principles of the present disclosure described herein may be readily applied to the processing of other digital documents.

In the present specification, an implementation showing a singular component should not be considered limiting; rather, the disclosure is intended to encompass other implementations including a plurality of the same component, and vice-versa, unless explicitly stated otherwise herein. Further, the present disclosure encompasses present and future known equivalents to the components referred to herein by way of illustration.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

For the sake of convenience, the terms used to describe the prior art and various embodiments of the present invention are defined below:
Vendor: A first entity that provides a good or service in exchange for a payment.
Customer: A second entity that provides a payment in exchange for a good or service.
Digital invoice: An invoice stored in a digital format, such as a native PDF file, a scanned document, a digital image, or another digital file type, wherein the content of the invoice is accessible for extraction of raw text data.

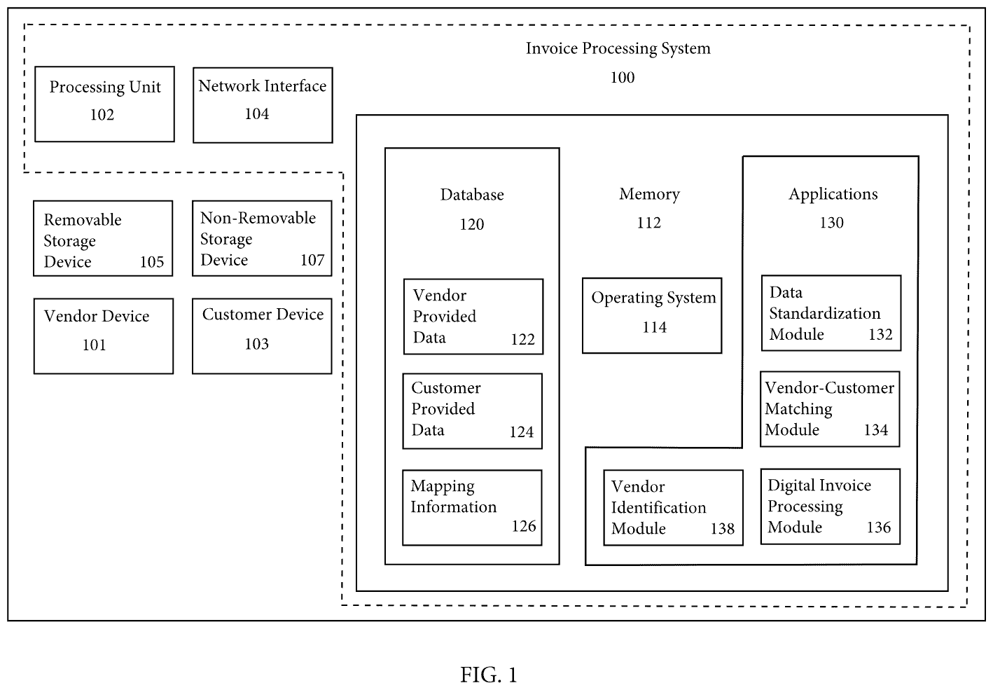

FIG. 1 is a block diagram illustrating example physical components (e.g. hardware) of an invoice processing system 100. The basic configuration is illustrated by those components within the dashed line. In this basic configuration, the invoice processing system 100 may include at least one processing unit 102, a network interface 104, and memory 112.

The processing unit 102 executes commands to perform the functions specified in flowcharts and/or block diagram blocks throughout this disclosure. It should be appreciated that processing may be implemented either locally via the processing unit 102 or remotely via various forms of wireless or wired networking technologies or a combination of both.

The term computer readable media as used herein may include computer storage media. Computer storage media may include volatile and nonvolatile, removable and non-removable media implemented in any method or technology for storage of information, such as computer readable instructions, data structures, or program modules. The memory 112, the removable storage device 105, and the non-removable storage device 107 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the invoice processing system 100. In some embodiments, such computer storage media may be part of the invoice processing system 100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Memory 112 may include various types of short and long-term memory as is known in the art. Memory 112 may be loaded with various applications 130 in the form of as computer readable program instructions. These computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, Python, or the like, and procedural programming languages, such as the “C” programming language or similar programming languages. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Applications 130 may include a data standardization module 132, a vendor-customer matching module 134, a digital invoice processing module 136, and a vendor identification module 138. Accordingly, memory 112 includes all necessary applications per each embodiment.

The data standardization module 132 is configured to generate standardized data based on vendor-provided mapping information, as will be described in greater detail below. Customer-provided data is standardized 124 by associating incoming data fields from vendor-provided data 122 with standardized internal data fields. Different vendors can utilize varying labels or formats for similar types of information. For example, a first vendor may refer to an invoice identifier as “Invoice No.,” a second vendor may refer to the same type of information as “Bill Number,” and a third vendor may refer to it as “Invoice ID.” Mapping information 126 enables the data standardization module 132 to recognize such variations and map each external data field to a corresponding standardized internal field.

During operation, the data standardization module 132 may reference mapping information 126 when receiving vendor-provided data 122 to ensure that incoming data elements are accurately interpreted and stored within the appropriate internal database fields. In this manner, mapping information 126 facilitates the consistent, accurate, and efficient processing of heterogeneous external data formats within the invoice processing system 100.

In certain embodiments, prior to receiving vendor-provided customer data, the data standardization module 132 may be configured to receive mapping information, such as mapping rules, from the vendor. For example, upon initial registration or onboarding of a vendor, the vendor may provide mapping information that defines relationships between the vendor's external data field labels and the internal data fields utilized by the invoice processing system 100. The mapping information may be submitted through a vendor device 101 in communication with the invoice processing system 100 and may be stored as part of mapping information 126. In some embodiments, the invoice processing system 100 may provide the vendor with a predefined template or interface for entering the mapping information. In other embodiments, the mapping information may be automatically extracted from a sample invoice or dataset provided by the vendor.

Upon receipt of the mapping information 126, the data standardization module 132 may perform a validation process to verify the completeness, accuracy, and consistency of the submitted mappings. For example, the data standardization module 132 may check whether each required internal field has been properly mapped to an external field label and may identify potential conflicts, missing entries, or formatting errors. In some embodiments, the system may provide the vendor with feedback or error notifications, requesting correction or completion of the mapping information prior to approval. After the mapping information has been successfully received and validated, the invoice processing system 100 may permit the vendor to submit vendor-provided customer data for processing. In this manner, the mapping information 126 ensures that data received from the vendor are properly aligned with the internal data schema, thereby enhancing system accuracy, consistency, and operational efficiency.

In certain embodiments, customer-provided data 124 may be automatically standardized within the invoice processing system 100 by prompting the customer to submit customer data in response to predefined fields during account creation. For example, when a customer initiates registration with the invoice processing system 100, the system may present the customer with a premade template, form, or graphical interface comprising a plurality of predefined data fields corresponding to the internal data schema utilized by the invoice processing system 100. Such predefined fields may include, for instance, customer name, customer address, customer Employer Identification Number (EIN), customer DUNS number, customer license number, and other relevant customer information.

In some embodiments, the predefined fields may be configured with data validation rules, such as requiring input in a specific format (e.g., nine-digit EIN format) or restricting selectable inputs to predefined choices via dropdown menus, radio buttons, or other input controls. Additionally, in certain embodiments, particular data fields may be designated as mandatory, while others may be optional, depending on system requirements. By requiring the customer to input data directly into the structured fields of the template, the data standardization module 132 ensures that customer-provided data 124 is captured in a standardized, structured, and validated format that aligns with internal processing requirements. In this manner, the data standardization module 132 minimizes the need for subsequent manual mapping, correction, or data transformation for customer-provided data 124, thereby enhancing system consistency, accuracy, and operational efficiency.

The vendor-customer matching module 134 is configured to match vendors to customers, as will be described in greater detail below. In one embodiment, the vendor-customer matching module 134 compares vendor-provided customer data with customer-provided customer data to identify shared data and/or potential matches. In an embodiment, if the amount of shared data exceeds a predefined threshold, the vendor is matched to the customer.

The vendor-customer matching module 134 may use matching algorithms such as, but not limited to, exact matching algorithms, fuzzy matching algorithms, probabilistic matching algorithms, rule-based matching algorithms, machine learning-based matching algorithms, and hierarchical or sequential matching processes.

In one embodiment, an exact matching algorithm may be employed, wherein one or more data fields from the vendor-provided customer data are compared to corresponding data fields from the customer-provided customer data to determine whether an exact match exists. For example, an exact match may be established if the vendor-provided customer name, telephone number, Employer Identification Number (EIN), and DUNS number identically match the corresponding customer-provided fields without variation.

In another embodiment, a fuzzy matching algorithm may be utilized to accommodate minor variations in the data. Fuzzy matching may involve the application of edit distance techniques (e.g., Levenshtein distance), phonetic matching algorithms (e.g., Soundex, Metaphone), or string similarity metrics (e.g., Jaccard similarity, cosine similarity) to determine approximate matches between fields. For instance, a customer name entered as “ABC Incorporated” may be determined to approximately match “ABC Inc.” under a fuzzy matching threshold.

In yet another embodiment, a probabilistic matching algorithm may be applied to generate a confidence score based on the similarity of multiple fields between the vendor-provided customer data and the customer-provided customer data. Each field may be assigned a weight based on its relative importance (e.g., greater weight to EIN matches than to address matches), and the system may calculate a composite likelihood score. Matches exceeding a predetermined probability threshold may be automatically made, while matches falling below the threshold may be flagged for manual review.

In some embodiments, a rule-based matching algorithm may be employed, wherein a set of predefined matching rules is evaluated. For example, a rule may require that the EIN fields match exactly and at least one of the customer name or address fields also match (either exactly or fuzzily) to establish a valid association between the vendor and customer.

In certain embodiments, the vendor-customer matching module 134 may also incorporate machine learning-based matching techniques. A machine learning model, such as a classification model or neural network, may be trained on historical matching data to predict the likelihood that a given vendor-provided customer data field corresponds to a given customer-provided customer data field. Features utilized for training may include exact and fuzzy match indicators, field similarity scores, metadata (e.g., timestamps, geolocation), and historical vendor-customer interaction patterns. Training data may include a plurality of labeled examples indicating whether specific pairs of data entries correspond to the same customer entity or not. Matches exceeding a predetermined probability threshold may be automatically made, while matches falling below the threshold may be flagged for manual review.

In certain embodiments, the machine learning model may comprise a classification model, such as a logistic regression model, a decision tree, a random forest, a gradient boosting model, or a neural network model. The model may output a probability score indicating the likelihood that the vendor-provided customer data and the customer-provided customer data refer to the same customer entity. If the probability score exceeds a configurable threshold, the invoice processing system 100 may automatically establish a match between the vendor and customer; otherwise, the potential match may be flagged for manual review.

In some embodiments, the machine learning model may be periodically retrained using newly labeled matching data obtained during operation of the invoice processing system 100. Retraining may occur automatically at scheduled intervals or may be triggered manually by an administrator. In certain embodiments, the system may utilize active learning techniques, wherein uncertain or borderline match candidates are prioritized for manual labeling to improve the training dataset and enhance the model's performance over time.

Additionally, the vendor-customer matching module 134 may implement a hierarchical or sequential matching process, wherein multiple matching algorithms are applied in a predetermined sequence. For example, the system may first attempt an exact match, and if an exact match is not found, proceed to apply a fuzzy matching algorithm, followed by a probabilistic or machine learning-based matching algorithm. Such a hierarchical approach may optimize processing efficiency while maximizing match accuracy.

In some embodiments, the matching algorithms may be dynamically configurable based on system parameters, user preferences, or observed performance. Thresholds for fuzzy similarity scores, probabilistic confidence scores, or machine learning model outputs may be adjustable to fine-tune the tradeoff between precision and recall in matching operations.

Through the use of such matching algorithms, individually or in combination, the vendor-customer matching module 134 may accurately associate vendor-provided customer data with customer-provided customer data, thereby facilitating reliable vendor-customer matching, reducing the risk of errors, and improving overall system performance.

In some embodiments, the customer is matched to the vendor in response to determining that preset matching criteria are satisfied.

In certain embodiments, the preset matching criteria are satisfied when the vendor-provided customer data and the customer-provided customer data include at least two, at least three, at least four, at least five, or at least ten exact field matches (i.e. at least 1-10 exact field matches). The field matches can drawn from [legal name, DBA name, street address line 1, city, state/province, ZIP/postcode, country, phone, email, website URL, EIN, DUNS, tax/VAT ID]. Exact matches can require equality after normalization (whitespace collapse, case folding, punctuation stripping, common abbreviation expansion).

In alternative embodiments, a higher-confidence threshold is used. The preset matching criteria x exact matches across the foregoing fields, with at least one match belonging to a “strong identifier” set [EIN, DUNS, tax/VAT ID].

In embodiments optimized for mixed evidence, the preset matching criteria are met when there are at least 1-10 exact matches and at least 1-10 fuzzy matches. Fuzzy matches include: Levenshtein distance ≤2 for tokens ≤12 characters, ≤10% of token length for longer tokens; Jaro-Winkler similarity ≥0.92; or phonetic equivalence under Soundex or Metaphone for name fields.

In probabilistic embodiments, each field contributes a weighted score (e.g., EIN: 0.40, DUNS: 0.25, phone: 0.10, legal name: 0.15, address: 0.10). The preset criteria are satisfied when the normalized composite score is greater than 0.85 or another preset threshold. Scores are computed from exact/fuzzy indicators and normalized to [0,1].

In machine-learning embodiments, a trained classifier (e.g., gradient-boosted trees or logistic regression) assigns a match probability; the preset matching criteria are satisfied when the model outputs ≥0.90 confidence or another preset confidence threshold at an operating point calibrated on held-out data to achieve ≥0.98 precision or another preset precision threshold.

In ensemble embodiments, exact/fuzzy rules, a probabilistic scorer, and a machine-learning classifier each produce a decision; the preset criteria require agreement by at least two of the three components OR unanimous agreement when no “strong identifier” is present.

In hierarchical embodiments, the preset matching criteria proceed in tiers: Tier-1 match if any strong identifier (EIN, DUNS, VAT) matches exactly; otherwise Tier-2 requires ≥1-10 exact matches including (city AND state) AND (phone OR email); otherwise Tier-3 requires ≥1-10 exact+≥1-10 fuzzy matches with name similarity ≥0.94 or another preset similarity threshold. The first satisfied tier issues the match.

In geographic-consistency embodiments, the preset matching criteria include a geospatial check: after address normalization and geocoding, the Haversine distance between addresses is ≤250 meters for U.S./EU urban records or ≤3 km for rural records; failing the distance rule vetoes the match regardless of other evidence.

In negative-evidence embodiments, the preset matching criteria include disqualifiers: any mismatch on a strong identifier (e.g., conflicting EINs) or verified sanction/blacklist flag results in a non-match even if other thresholds are met. Disqualifiers can supersede positive evidence.

In token-set embodiments for names and addresses, the preset matching criteria require a token-set Jaccard similarity ≥0.85 OR a TF-IDF cosine similarity ≥0.90 on normalized token bags; hyphenation, punctuation, and common corporate suffixes (Inc., LLC, Ltd.) can be removed before scoring.

In contact-channel embodiments, the preset matching criteria require convergence across at least two independent channels: (i) phone match (E.164-normalized) AND (ii) email match (case-insensitive local part, exact domain), OR phone match AND street address exact match.

In proportion-based embodiments, the preset matching criteria require that ≥70% of available comparable fields match exactly and ≥85% match either exactly or fuzzily, where the denominator excludes null/unknown fields and fields judged non-comparable by policy.

In document-corroboration embodiments, the preset matching criteria require at least two corroborating documents (e.g., invoice header and vendor onboarding form) to independently satisfy either (i) ≥3 exact matches each, or (ii) one strong identifier match plus ≥1 exact matches.

In temporal-consistency embodiments, the preset matching criteria are satisfied only if time-sensitive fields (e.g., DBA name, address) agree within an allowed staleness window (e.g., last-updated timestamps within 180 days) or if archival discrepancies are explained by a change-log mapping table.

In threshold-pair embodiments, the preset matching criteria use joint thresholds: name similarity ≥0.95 AND address similarity ≥0.90 AND at least one of [phone exact, email exact, EIN exact]. Failure to meet any one of the joint thresholds yields a non-match.

In confidence-band embodiments, the preset matching criteria define a three-zone policy on a calibrated score S∈[0,1]: match if S≥0.90; non-match if S≤0.60; otherwise (0.60<S≤0.90) route to manual review. The criteria may be tightened to S≥0.95 under high-risk policies.

In field-group embodiments, fields are partitioned into groups: Identity {EIN, DUNS, VAT}, Name {legal, DBA}, Location {street, city, state, ZIP, country}, and Contact {phone, email}. The preset matching criteria require ≥1 Identity match OR (≥1 Name AND ≥2 Location AND ≥1 Contact exact matches).

In alias-aware embodiments, the preset matching criteria allow matches when legal name exact-matches OR DBA name fuzzy-matches at ≥0.94, provided that (i) the address normalizes to the same canonical location and (ii) any of [EIN, DUNS, phone] matches exactly.

In blocker-first embodiments, a quick “blocking” key (e.g., normalized ZIP+soundex(legal name root)) is computed; only candidate pairs sharing a blocking key are evaluated. The preset matching criteria are then applied; absence of blocking key agreement yields non-match by definition.

In rules-only embodiments (no machine learning models), the preset matching criteria comprise deterministic checks: (i) ≥3-10 exact matches, including at least one of [EIN, DUNS, VAT], (ii) name Jaro-Winkler ≥0.93, and (iii) address token Jaccard ≥0.80, with the negative-evidence veto applied.

The digital invoice processing module 136 is configured to extract data from one or more digital invoices provided by the vendor, as will be described in greater detail below. In certain embodiments, the digital invoice processing module 136 may utilize one or more digital invoice processing algorithms to extract customer data from a digital invoice. The digital invoice processing algorithms may include, but are not limited to, optical character recognition (OCR) algorithms, template-based extraction algorithms, machine learning-based classification algorithms, natural language processing (NLP) algorithms, confidence scoring algorithms, and post-processing validation techniques.

In one embodiment, an OCR algorithm may be applied to the digital invoice to extract raw text content from the invoice image, native PDF, scanned document, or other digital file format. The OCR algorithm may convert graphical representations of text into machine-readable characters and output the raw textual data in an unstructured or semi-structured form.

Following OCR processing, a machine learning-based classification algorithm may be employed to analyze the extracted text and classify individual text elements into predefined customer data fields. For instance, the classification algorithm may determine that a particular text string corresponds to a customer name, address, Employer Identification Number (EIN), customer license number, or other relevant field. The classification model may be implemented using supervised learning methods such as decision trees, random forests, support vector machines, deep neural networks, or gradient boosting frameworks. In certain embodiments, the model may generate a classification confidence score for each extracted field, indicating the likelihood that the field has been correctly identified.

In another embodiment, a template-based extraction algorithm may be utilized. In such embodiments, the digital invoice processing module 136 may match the digital invoice to a known template based on vendor identifiers, invoice layout patterns, metadata, or file signatures. Once a matching template is identified, predefined extraction rules, such as coordinate-based or keyword-based field locators, may be applied to extract the customer data with high precision.

In yet another embodiment, natural language processing (NLP) algorithms may be applied to the OCR-extracted text to further refine customer data extraction. NLP techniques such as named entity recognition (NER), part-of-speech tagging, dependency parsing, and semantic similarity analysis may be used to disambiguate fields, identify relationships between data elements, and detect contextual clues that aid in field classification and segmentation.

In some embodiments, the digital invoice processing module 136 may incorporate confidence scoring and thresholding techniques, wherein each extracted field is assigned a confidence score based on the outputs of the machine learning model, the template match quality, or the NLP parsing consistency. Fields with confidence scores exceeding a predetermined threshold may be automatically accepted, while fields below the threshold may be flagged for manual verification or correction.

Post-processing validation techniques may also be employed to improve data quality. For example, extracted postal addresses may be validated against known address databases, EINs may be checked for proper formatting and checksum validation, and customer names may be cross-referenced against existing customer records. In the event that inconsistencies, missing data, or low-confidence extractions are detected, the digital invoice processing module 136 may prompt manual review, suggest corrective actions, or automatically apply error-correction heuristics.

In certain embodiments, the digital invoice processing module 136 may further implement a feedback loop mechanism, wherein corrections or confirmations provided by users during manual review are recorded and used to update machine learning models, improve template extraction rules, or refine NLP algorithms over time. In this manner, the system may continuously adapt and enhance its extraction accuracy based on operational experience.

The vendor identification module 138 is configured to identify vendors, as will be described in greater detail below. In certain embodiments, the vendor identification module 138 may utilize one or more search algorithms to identify a potential vendor based on vendor-provided keywords and a customer-provided search query. The search algorithms may include, but are not limited to, exact keyword matching algorithms, fuzzy keyword matching algorithms, synonym-based matching algorithms, semantic similarity algorithms, and weighted relevance scoring algorithms.

In one embodiment, an exact keyword matching algorithm may be utilized to compare the customer-provided search query to the set of vendor-provided keywords and identify potential vendors whose keywords exactly match or contain terms corresponding to the search query. For example, if a customer provides a search query of “oranges” and a potential vendor has provided a keyword of “orange supplier,” the system may identify the potential vendor based on a direct match or substring match.

In another embodiment, a fuzzy keyword matching algorithm may be employed to account for minor differences between the search query and the vendor-provided keywords. Fuzzy matching techniques, such as edit distance (e.g., Levenshtein distance) or phonetic similarity (e.g., Soundex), may be applied to determine whether a vendor-provided keyword sufficiently approximates the customer's search query, thereby allowing for tolerance of misspellings, pluralizations, or related variations.

In yet another embodiment, a synonym-based matching algorithm may be utilized. The system may reference a synonym dictionary or thesaurus to expand the search query into related terms and identify vendor keywords that match either the original query or an associated synonym. For instance, a search query for “citrus fruits” could match vendor keywords such as “orange vendor,” “lemon vendor,” or “lime vendor” based on synonym relationships.

In further embodiments, semantic similarity algorithms may be applied to assess the conceptual relatedness between the customer's search query and the vendor-provided keywords. Techniques such as word embedding models (e.g., Word2Vec, GloVe) or transformer-based models (e.g., BERT) may be employed to generate vector representations of both the search query and vendor keywords and identify vendors whose keywords exhibit high semantic similarity to the query.

In some embodiments, the vendor identification module 138 may calculate a weighted relevance score for each potential vendor based on the degree of matching between the customer-provided search query and the vendor-provided keywords. Factors such as exact match presence, fuzzy match score, synonym match strength, and semantic similarity score may be combined into an overall relevance metric. Vendors exceeding a predetermined relevance threshold may be identified as matching vendors and selected for presentation to the customer.

Upon identifying one or more potential vendors based on the search query, the vendor identification module 138 may transmit vendor information, such as the vendor's name, address, phone number, product catalog, promotional materials, advertisements, or coupons, to the customer. In this manner, the system facilitates discovery of potential vendors aligned with customer needs, even prior to the initiation of any business transaction between the customer and vendor.

In certain embodiments, after identifying one or more potential vendors based on the customer-provided search query, the vendor identification module 138 may further rank or filter the identified vendors based on additional criteria. For example, the system may evaluate vendor attributes such as pricing information, product availability, geographic proximity to the customer, vendor reputation ratings, historical transaction records, promotional offers, or customer-specific preferences. Each vendor may be assigned a ranking score or priority level based on a weighted combination of such factors. In some embodiments, the system may present the ranked list of vendors to the customer, allowing the customer to review the most relevant or favorable vendors first. In other embodiments, the system may apply filtering rules to exclude vendors that do not meet certain threshold requirements, such as minimum reputation scores or maximum distance from the customer. By incorporating ranking and filtering operations, the vendor identification module 138 may further enhance the efficiency and relevance of vendor discovery for the customer.

Memory 112 may also include an operating system 114 and a database 120 loaded with vendor-provided data 122, customer-provided data 124, and mapping information 126, as will be further discussed. In certain embodiments, the database 120 may be implemented locally within the invoice processing system 100, whereas in other embodiments, the database 120 may be implemented remotely, such as via a cloud computing environment (e.g., a remote server cluster provided by Amazon Web Services®, Microsoft Azure®, Google Cloud Platform®, or similar distributed storage and processing services).

The operating system 114 is suitable for controlling the operation of the invoice processing system 100.

Vendor-provided data 122 may comprise vendor-provided customer data (e.g., customer name, customer address, telephone number, customer Employer Identification Number (EIN), customer DUNS number, customer license number, etc.), vendor-provided invoice data (e.g., invoice number, invoice date, invoice amount, due date, etc.), and/or other vendor-provided data (e.g., vendor information such as key words associated with the vendor, product catalogs, and promotional materials). Vendor-provided data 122 may be received from a vendor through a vendor device 101 in communication with the invoice processing system 100. Alternatively, vendor-provided data 122 may be received when it is extracted from one or more digital invoices provided by the vendor. It should be appreciated that vendor-provided invoice data can include digital invoices received from the vendor.

Customer-provided data 124 may comprise customer-provided customer data (e.g., customer name, customer address, telephone number, customer Employer Identification Number (EIN), customer DUNS number, customer license number, etc.) and/or other customer-provided data 124 (e.g., customer information such as business type). Customer-provided data 124 may be received from a customer through a customer device 103 in communication with the invoice processing system 100. Alternatively, customer-provided data 124 may be received when a customer creates an account with the invoice processing system 100. For example, the customer provides their customer data into a premade template.

Mapping information 126 may comprise one or more mapping rules that define relationships between external field identifiers and internal field names, and may further specify associated data types, formatting instructions, and validation rules. In one embodiment, a mapping rule may associate an external field labeled “Invoice No.” with an internal field named “invoice_number” of type string. In another embodiment, mapping data 126 may specify that a field labeled “Bill Date” corresponds to an internal field named “invoice_date” of type date. In certain embodiments, mapping information 126 may also specify transformations to be performed on incoming data, such as converting date formats (e.g., from MM/DD/YYYY to YYYY-MM-DD), converting currencies (e.g., from euros to U.S. dollars), or parsing combined fields into separate data elements (e.g., separating a full name field into a first name field and a last name field).

The invoice processing system 100 may further comprise a vendor device 101 and a customer device 103. The vendor device 101 may be any device that permits a vendor to access the system 100 such as a computer or smartphone. Vendor devices may be configured to support a vendor portal that permits easy access to the system 100. The customer device 103 may be any device that permits a customer to access the invoice processing system 100 such as a computer or smartphone. Customer devices may be configured to support a customer portal that permits easy access to the invoice processing system 100 and/or a payment system.

In certain embodiments, the invoice processing system 100 may be implemented in the form of a software application that, when downloaded and installed onto a client device (e.g., the vendor device 101 or customer device 103), configures the client device to operate as an invoice processing system 100. For example, the software application may be downloaded from a server, an application marketplace, or another distribution platform to a client device, such as a desktop computer, laptop computer, tablet, or smartphone. Upon installation, the software application may cause the client device to perform various functions associated with the invoice processing system 100, including, but not limited to, receiving vendor-provided data 122 and customer-provided data 124, standardizing received data based on the mapping data 126, executing invoice data extraction and validation processes, generating internal database records, and communicating with external vendor devices 101, customer devices 103, and/or remote servers.

In certain embodiments, the software application may operate in conjunction with remotely hosted services, such as cloud-based databases or processing engines, thereby enabling the client device to leverage external resources while still performing localized invoice processing operations. In other embodiments, the software application may be configured to operate substantially autonomously, wherein all necessary data storage and processing are performed locally on the client device. The software application may also be configured to receive periodic updates, patches, or configuration changes from a remote server to maintain compatibility with evolving data formats, security standards, or feature enhancements. In this manner, a client device may be transformed into a specialized machine configured to perform the invoice processing operations described herein, thereby facilitating flexible, scalable, and distributed deployment of the invoice processing system 100.

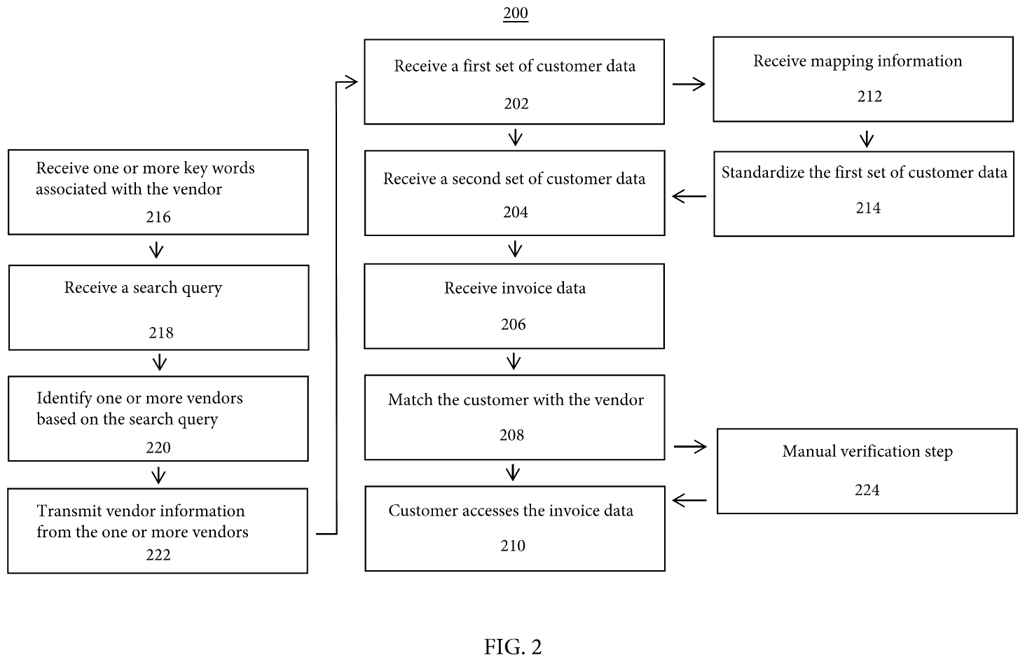

FIG. 2 is a flowchart showing steps of an invoice processing method 200, according to an embodiment. The invoice processing method 200 can be carried out on the invoice processing system 100.

At step 202, a first set of customer data (customer-provided customer data) is received from the customer. For example, the customer name, address, telephone number, and Employer Identification Number are received.

At step 204, a second set of customer data (vendor-provided customer data) is received from the vendor. For example, the customer name, address, telephone number, and Employer Identification Number are received.

At step 206, invoice data (vendor-provided invoice data) is received from the vendor. For example, the invoice number(s), date(s), amount(s), and due date(s) are received. According to an embodiment, the invoice data is received when the digital invoice processing module 136 utilizes one or more digital invoice processing algorithms to extract the invoice data from a vendor-provided digital invoice. Alternatively, the invoice data is received when the vendor inputs the invoice data through a vendor device 101 in communication with the invoice processing system 100.

At step 208, the customer is matched to the vendor based on the first and second sets of customer data. For example, the customer is matched to the vendor, using the vendor-customer matching module 134, based on a shared customer name, address, telephone number, and Employer Identification Number in the first and second sets of customer data. In some embodiments, the customer is matched to the vendor in response to preset matching criteria being satisfied.

At step 210, the customer is permitted to access the invoice data (vendor-provided invoice data) after the customer is matched with the vendor. For example, the customer can access the invoice data by accessing a copy of the original digital invoice received from the vendor (e.g., the original PDF document). In some embodiments, the customer is permitted to access the vendor information after the customer is matched with the vendor. In other embodiments, updates to the vendor's product catalog or pricing are continuously or periodically transmitted to the customer after the customer is matched with the vendor. In yet other embodiments, the vendor's promotional materials are continuously or periodically transmitted to the customer after the customer is matched with the vendor. Alternatively, when the invoice data is extracted from a digital invoice, the customer can access the invoice data in a simplified format or as a generated summary thereof. Yet alternatively, the customer may access the invoice data by selecting a uniform resource locator (URL) that directs the customer to a location where the invoice data is available for viewing.

This invoice processing method 200 provides several technical advantages that improve the management and accessibility of invoice data within the invoice processing system 100. By receiving a first set of customer-provided customer data and a second set of vendor-provided customer data (steps 202 and 204), the system enables cross-verification between independently submitted data sources, thereby increasing the reliability and accuracy of customer identification. This approach reduces reliance on a single party's data entry, mitigating the risks of data inconsistencies or inaccuracies that could otherwise disrupt invoice delivery and processing.

Matching the customer to the vendor based on shared customer information (step 208) ensures that invoice data and vendor communications are securely and accurately associated with the intended customer entity. This matching process improves data security and reduces the risk of unauthorized access to sensitive financial information by ensuring that only properly verified customers can access vendor-provided invoice data.

Furthermore, by restricting access to vendor-provided invoice data until after a successful match is established (step 210) and/or the match is manually verified (step 224), the method strengthens control over sensitive business transactions and improves compliance with data privacy and access control standards. Once a match is established, providing the customer with access to digital invoices and associated vendor information enhances transparency and customer satisfaction by enabling real-time or near-real-time visibility into pending invoices and transaction history.

In certain embodiments, the transmission of updates to the vendor's product catalog, pricing, or promotional materials following a successful match further improves the commercial relationship between the vendor and the customer. Customers receive timely and relevant updates that may inform purchasing decisions, while vendors gain an efficient channel for marketing and customer engagement. The invoice processing system streamlines invoice access, invoice management, vendor communications, and promotional material delivery into a unified workflow tied to a verified match.

At optional step 212, mapping information is received from the vendor. For example, mapping information that defines relationships between the vendor's external data field labels and the internal data fields utilized by the invoice processing system 100 are received from the vendor.

At optional step 214, the second set of customer data (vendor-provided customer data) is standardized based on the mapping information. For example, the data standardization module 132 applies the mapping information received from the vendor to align external data field labels with corresponding internal data fields, thereby transforming the vendor-provided customer data into a standardized format compatible with internal system requirements of the invoice processing system.

At optional step 216, one or more keywords associated with a potential vendor are received from the potential vendor. For example, keywords of ‘orange supplier’, ‘lemon distributor’, and ‘lime vendor’ are received from the potential vendor.

At optional step 218, a search query is received from the customer. For example, a search query of ‘oranges’ is received from the customer.

At optional step 220, potential vendors are identified based on the search query. For example, the potential vendor is identified because the potential vendor keyword ‘orange supplier’ matches or corresponds to the customer search query ‘oranges’.

At optional step 222, vendor information of the identified potential vendor is transmitted to the customer. For example, the potential vendor's name, address, phone number, and product catalog are transmitted to the customer. It should be appreciated that vendor information can include promotional materials such as advertisements and coupons.

By transmitting vendor information to the customer, the customer may review the potential vendor's offerings. The customer may initiate contact with the potential vendor and provide customer data, which the potential vendor may then provide to the invoice processing system 100 during step 202. Through these optional steps, the invoice processing system 100 may establish a match between the customer and the potential vendor prior to the conduct of any formal business transactions, thereby facilitating streamlined onboarding and faster engagement between the parties.

At optional step 224, the customer and/or vendor are prompted to manually verify a customer-vendor match identified at step 208. For example, a verification prompt is transmitted to the customer and/or vendor, where the verification prompt includes match-related information such as matching data fields, (e.g., matching customer name, address, telephone number, and Employer Identification Number). The customer and/or vendor may review the match-related information and indicate that the match is correct or incorrect. In some embodiments, manual verification may be performed through a graphical user interface (GUI), mobile application interface, email link, or other electronic communication. In further embodiments, the system may require verification only when the automatic match confidence score falls below a predefined threshold.

Incorporating an optional manual verification step improves overall system 100 accuracy and reliability by providing a safeguard against false positives generated by automated matching algorithms. By allowing the customer, the vendor, or both parties to confirm or reject a proposed match, the system reduces the likelihood of mismatches that could result in unauthorized invoice access or operational errors. Selectively triggering manual verification based on confidence scores or data inconsistencies further balances accuracy with processing efficiency, maintaining high system throughput while reserving human intervention for ambiguous cases. Additionally, offering intuitive digital interfaces for verification enhances user experience and system trustworthiness, while supporting compliance with varying business and regulatory requirements.

In certain embodiments, the digital invoice processing module 136 may be further configured to identify a product and/or service received by the customer based on the invoice data received from a vendor. For example, the digital invoice processing module 136 may parse the vendor-provided invoice data to extract line-item descriptions, product codes, service descriptions, or other transactional details that specify goods or services delivered to the customer. The identification process may utilize string parsing techniques, keyword extraction, product catalog cross-referencing, or natural language processing (NLP) algorithms to accurately determine the specific products and/or services associated with the invoice data.

The digital invoice processing module 136 may also be configured to receive other invoice data from another vendor. Such other invoice data may similarly include line-item details, product or service descriptions, product identifiers (e.g., SKUs, UPCs), pricing information, and associated metadata. Upon receiving the other invoice data, the digital invoice processing module 136 may parse and analyze the other invoice data to identify products and/or services offered by the other vendor. In some embodiments, the identification process may involve matching extracted product or service information against a vendor-provided catalog, third-party product databases, or standardized taxonomies.

After identifying the products and/or services from both the initial vendor and the other vendor, the vendor-customer matching module 134 may apply a matching algorithm to match the customer with the other vendor based on shared products and/or services. In one embodiment, the matching algorithm may perform direct comparison of product names, identifiers, or classifications to identify overlaps. In another embodiment, the matching algorithm may utilize fuzzy matching, semantic similarity, or synonym expansion techniques to account for variations in product naming conventions. If the customer has previously received a product or service that the other vendor also offers, the system may establish a match, thereby indicating that the other vendor is a potential alternative or additional supplier for the customer.

By matching the customer to the other vendor based on shared products and/or services, the vendor-customer matching module 134 facilitates vendor discovery, alternative sourcing, and competitive pricing opportunities for the customer. In certain embodiments, the system may further transmit the other vendor's information, such as name, address, contact details, product catalog, and promotional offers, to the customer following a successful match.

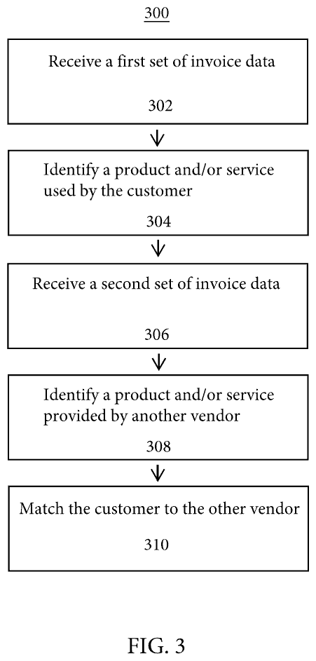

FIG. 3 is a flowchart showing steps of an invoice processing method 300, according to another embodiment. The invoice processing method 300 can be carried out on the invoice processing system 100.

At step 302, a first set of invoice data (vendor-provided invoice data) is received from a first vendor. For example, the customer name, invoice amount, merchandise type, and invoice due date are received. According to an embodiment, the invoice data is received when the digital invoice processing module 136 utilizes one or more digital invoice processing algorithms to extract the invoice data from a vendor-provided digital invoice. Alternatively, the invoice data is received when the vendor inputs the invoice data through a vendor device 101 in communication with the invoice processing system 100.

At step 304 a customer and a product and/or service received by the customer is identified based on the first set of invoice data. For example, a merchandise type of ‘oranges’ in the invoice data indicates that the customer ordered oranges from the first vendor. According to an embodiment, the customer and the product and/or service received by the customer are identified when the digital invoice processing module 136 uses one or more digital invoice processing algorithms to extract the customer and the product and/or service received by the customer from the invoice data,

At step 306, a second set of invoice data (other vendor-provided customer data) is received from a second vendor. For example, the customer name, invoice amount, merchandise type, and invoice due date are received. According to an embodiment, the second invoice data is received when the digital invoice processing module 136 utilizes one or more digital invoice processing algorithms to extract the second invoice data from a second vendor-provided digital invoice. Alternatively, the invoice data is received when the second vendor inputs the invoice data through a vendor device 101 in communication with the invoice processing system 100.

At step 308, a product and/or service offered by the second vendor is identified based on the second set of invoice data. For example, a merchandise type of ‘citrus fruits’ indicates that the vendor has sold citrus fruits to another customer.

At step 310, the customer is matched to the other vendor based on the first and second sets of invoice data. For example, the customer is matched to the other vendor based on a similarity in the merchandise types of ‘orange’ and ‘citrus fruits’.

This invoice processing method 300 provides several technical advantages that enhance vendor-customer matching and expand business opportunities for customers. By analyzing invoice data from multiple vendors, the system can intelligently identify potential vendor-customer matches based on similarities in offerings. This enables customers to discover alternative or complementary vendors capable of supplying related goods or services, even when those vendors have not previously conducted business with the customer. Matching based on product or service similarities also improves sourcing flexibility, supports competitive pricing opportunities, and promotes vendor diversity. Using this method 300, the invoice processing system 100 leverages existing invoice data without requiring explicit customer searches or manual vendor discovery processes.

It should be appreciated that all method steps can be executed automatically and in real-time or near-real-time by the invoice processing system 100. In certain embodiments, the invoice processing system 100 may be further configured to facilitate integrated payment processing between the customer and the vendor. For example, upon the customer's initiation of a payment corresponding to a vendor-provided invoice, the invoice processing system 100 may execute a bank integration process in which funds are electronically withdrawn from the customer's designated financial account and deposited into the vendor's designated financial account. Such integration may be implemented via secure communication protocols with one or more external payment gateways, automated clearing house (ACH) systems, or other financial transaction networks. In some embodiments, payment processing may be initiated automatically following the manual verification step 224, while in other embodiments, payment processing may be scheduled for execution at a specified future date. The bank integration may further support transaction verification, payment status tracking, and automatic reconciliation of invoice records within the invoice processing system 100.

I claim:

1. An invoice processing system comprising:
memory storing instructions; and
a processing device executing the instructions, wherein the instructions, when executed by the processing device, configure the invoice processing system to:
receive, from a customer, a first set of customer data associated with the customer;
receive, from a vendor, a second set of customer data associated with the customer;
receive, from the vendor, invoice data associated with the customer;
determine, using one or more matching algorithms selected from the group consisting of: (i) an exact-matching algorithm that compares corresponding fields in the first and second sets of customer data, (ii) a fuzzy-matching algorithm employing at least one edit-distance technique including Levenshtein distance, at least one phonetic encoding including Soundex or Metaphone, or at least one string-similarity metric including Jaccard similarity or cosine similarity, (iii) a probabilistic-matching algorithm that generates a composite likelihood score from multiple field similarities using field-importance weights, or (iv) a machine-learning classifier trained on labeled vendor-customer pairs and configured to output a match probability, whether the first and second sets of customer data satisfy preset matching criteria;
responsive to determining that the preset matching criteria are satisfied, match the customer with the vendor;
responsive to matching the customer with the vendor, enable the customer to access the invoice data.

2. The invoice processing system of claim 1, wherein the instructions, when executed by the processing device, further configure the invoice processing system to:
receive, from the vendor, mapping information; and
standardize the second set of customer data based on the mapping information.

3. The invoice processing system of claim 1, wherein
the second set of customer data is received from the vendor when the second set of customer data is extracted from one or more digital invoices provided by the vendor.

4. The invoice processing system of claim 3, wherein
the second set of customer data is extracted from the one or more digital invoices using a module configured to perform optical character recognition and raw text classification.

5. The invoice processing system of claim 3, wherein
extracting the second set of customer data from the one or more digital invoices comprises steps of:
extracting, using a module configured to perform optical character recognition, raw text from the one or more digital invoices; and
classifying, using a machine learning module, the extracted raw text to identify the second set of customer data.

6. The invoice processing system of claim 1, wherein the instructions, when executed by the processing device, further configure the invoice processing system to:
identify, based on the invoice data, a product and/or service received by the customer;
receive, from an other vendor, other invoice data;
identify, from the other invoice data, a product and/or service offered by the other vendor;
match, using a matching algorithm, the customer with the other vendor based on a shared product and/or service.

7. The invoice processing system of claim 1, wherein the instructions, when executed by the processing device, further configure the invoice processing system to:
receive, from the vendor, one or more keywords associated with the vendor;
receive, from the customer, a search query;
identify, using a keyword matching algorithm, one or more vendors based on the search query; and
transmit, to the customer, vendor information from the one or more vendors.

8. The invoice processing system of claim 7, wherein
the vendor information includes promotional materials.

9. The invoice processing system of claim 1, wherein
determining whether the first and second sets of customer data satisfy the preset matching criteria requires using an exact-matching algorithm that compares corresponding fields in the first and second sets of customer data;
the preset matching criteria are satisfied when the first and second sets of customer data include at least three exact field matches.

10. The invoice processing system of claim 1, wherein
determining whether the first and second sets of customer data satisfy the preset matching criteria requires using (ii) a fuzzy-matching algorithm employing at least one edit-distance technique including Levenshtein distance, at least one phonetic encoding including Soundex or Metaphone, or at least one string-similarity metric including Jaccard similarity or cosine similarity;
the preset matching criteria are satisfied when the first and second sets of customer data include at least three fuzzy field matches.

11. The invoice processing system of claim 1, wherein
determining whether the first and second sets of customer data satisfy the preset matching criteria requires using a probabilistic-matching algorithm that generates a composite likelihood score from multiple field similarities using field-importance weights;
the preset matching criteria are satisfied when the composite likelihood score for the first and second sets of customer data exceeds a predetermined probability threshold.

12. The invoice processing system of claim 1, wherein
determining whether the first and second sets of customer data satisfy the preset matching criteria requires using a machine-learning model that generates a composite likelihood score;
the preset matching criteria are satisfied when the composite likelihood score for the first and second sets of customer data exceeds a predetermined probability threshold.

13. A computer-implemented method of processing an invoice, comprising:
receiving, from a customer, a first set of customer data associated with the customer;
receiving, from a vendor, a second set of customer data associated with the customer;
receiving, from the vendor, invoice data associated with the customer;
determining, using one or more matching algorithms selected from the group consisting of: (i) an exact-matching algorithm that compares corresponding fields in the first and second sets of customer data, (ii) a fuzzy-matching algorithm employing at least one edit-distance technique including Levenshtein distance, at least one phonetic encoding including Soundex or Metaphone, or at least one string-similarity metric including Jaccard similarity or cosine similarity, (iii) a probabilistic-matching algorithm that generates a composite likelihood score from multiple field similarities using field-importance weights, or (iv) a machine-learning classifier trained on labeled vendor-customer pairs and configured to output a match probability, whether the first and second sets of customer data satisfy preset matching criteria;
responsive to determining that the preset matching criteria are satisfied, matching the customer with the vendor;
responsive to matching the customer with the vendor, enabling the customer to access the invoice data.

14. Non-transitory computer readable media containing executable instructions, that, when executed by a processing device, configure a system to:
receive, from a customer, a first set of customer data associated with the customer;
receive, from a vendor, a second set of customer data associated with the customer;
receive, from the vendor, invoice data associated with the customer;
determine, using one or more matching algorithms selected from the group consisting of:
(i) an exact-matching algorithm that compares corresponding fields in the first and second sets of customer data, (ii) a fuzzy-matching algorithm employing at least one edit-distance technique including Levenshtein distance, at least one phonetic encoding including Soundex or Metaphone, or at least one string-similarity metric including Jaccard similarity or cosine similarity, (iii) a probabilistic-matching algorithm that generates a composite likelihood score from multiple field similarities using field-importance weights, or (iv) a machine-learning classifier trained on labeled vendor-customer pairs and configured to output a match probability, whether the first and second sets of customer data satisfy preset matching criteria;
responsive to determining that the preset matching criteria are satisfied, match the customer with the vendor;
responsive to matching the customer with the vendor, enable the customer to access the invoice data.
